(19) United States
(12) Patent Application Publication
(10) Pub. No.: US 2017/0298692 A1
(43) Pub. Date: Oct. 19, 2017

(54) Mid-step ladder attachment

(71) Applicant: Michael Knapp, St. Joseph, MO (US)

(72) Inventor: Michael Knapp, St. Joseph, MO (US)

(21) Appl. No.: 15/431,676

(22) Filed: Feb. 13, 2017

Related U.S. Application Data
(60) Provisional application No. 62/294,967, filed on Feb. 12, 2016.

(51) Int. Cl. E06C 7/16

(52) U.S. Cl. CPC E06C 7/16

(57) ABSTRACT

A ladder attachment device having support frames to which a ladder rung-like standing platform is attached, The support frames are configured to mount onto adjacent ladder rungs, rendering the standing platform vertically midway between them.

### BACKGROUND

The present invention generally relates to ladder accessories, and it is specifically directed to a device for attaching to a rigid, portable ladder for the purpose of providing additional surface area for user foot placement—even more specifically for providing that foot placement surface at a vertical position that is in-between those of an adjacent pair of ladder rungs.

For thousands of years, man has utilized the ladder to facilitate doing everything from moving between different elevations to constructing and performing work on structures. Throughout that entire history, man has recognized that a few dangers which are virtually always associated with ladder usage. One such danger is the possibility of the bottom ends of ladder rails sliding along the floor or ground surface upon which they rest. Consequently, a number of anti-slip attachments for placing at the base of a ladder have been developed, in the prior art, to help prevent that dangerous phenomenon from occurring.

Another common drawback of ladder usage is the foot discomfort and real trauma that can result from a user standing on relatively narrow (in the direction of foot length) ladder rungs. That risk lends itself to another, even more substantial, hazard: the prospect of a user's feet slipping, or of a user simply losing balance along any of the relatively small foot-supporting surfaces provided by each rung. There have been many efforts to mitigate that danger as well. In fact, the prior art is replete with devices designed to be securely attached to a rigid ladder so as to provide broader standing platforms than the rungs do. Furthermore, aside from improving user comfort and safety, many of these devices provide the secondary benefit of enabling the user to rest objects (e.g., paint cans, hand tools, etc.) upon them within convenient arm's reach.

For example, U.S. Pat. No. 7,861,826 to Meyers et al. discloses a ladder platform that is formed, principally, by a platform step that, near one end, is pivotally attached to a crossbar that is, itself, attached to a pair of hanger arms. The end of the Meyers platform step features a connector assembly for coupling the platform step to one rung of a ladder, while the hanger arms have connector assemblies for coupling them to a higher rung. Therefore, when properly^{,} attached to a ladder_{;} the platform step forms a standing surface that extends inward from the ladder (i.e., extends in the horizontal direction that the upper end of the ladder is leaning) and forms a larger standing area than does the rung to which it is coupled. Ladder attachments that similarly extend a rung's support surface are disclosed by U.S. Pat. No. 5,836,420 to Marky, Jr.; U.S. Pat. No. 5,465,809 to Panicci; U.S. Pat. No. 5,388,665 to Newman; and U.S. Pat. No. 5,052,515 to Nowlan among others. Although, in some cases, the attachment's standing platform extends outward from the ladder rung and may actually present a hazard in that the ladder rails are not able to serve as lateral guardrails that obstruct the user's feet from inadvertently stepping off of a lateral end of the attachment platform. So, while alleviating one comfort/safety concern associated with ladder usage, some of these prior art ladder attachment devices may expose their users to an entirely different danger.

Nevertheless, despite the many and varied ways in which the aforementioned and other devices of the prior art have attempted to address issues of comfort and safety of ladder use, that the present inventor is aware, no concerted attempt has been made to address the issue of a ladder not being configured to support a particular user at the optimum vertical position for that user to perform work. In other words, because of the uniform spacing of ladder rungs, each of two adjacent rungs may be positioned slightly too high or too low for a particular user to stand upon while operating on a particular workpiece. This is an especially likely possibility when the task involved using tools of a type that, typically, are neither length-adjustable nor available in a substantial range of length sizes (e.g., screwdrivers and wrenches). That is because, given the height and arm length of the ladder user, standing on the most ideal ladder rung may force him to position his hands and arms in such a way that is considerably more fatiguing than would he the case if he were able to stand on a platform positioned just a few inches higher or lower than that best available rung.

In accordance with Occupational Safety and Health Administration (OSHA) standards, the spacing of portable ladder rungs must be uniform throughout a ladder and within a range of 10 to 14 inches from rung centerline to adjacent rung centerline (29 C.F.R. 1926.1053(a)(2) & 1926.1053 (a)(3)(i)). Therefore, with any given portable ladder, a user may be forced to stand on a rung that is 5 to 7 inches either higher or lower than is the perfect standing platform position for that user to perform a particular task. As a result, if the user elects to stand atop the rung that is slightly higher than ideal, he will, invariably, have to crouch or hunch in a way that may cause him knee or back discomfort. Conversely, if he chooses to stand atop the alternative best choice rung—the adjacently lower one—he may end up standing on the balls of his feet or holding his arms in a higher than desirable position. That could may cause foot, calf or shoulder fatigue to ensue.

Consequently, there is an outstanding need for a new device that can be securely attached to a typical, rigid, portable ladder for the purpose of providing a standing platform that is positioned vertically between any of an adjacent pair of rungs along the ladder. Furthermore, there is desire for such a device to provide a standing platform that is positioned substantially between the rails of the ladder to which it is attached so that the rails function as lateral barriers to feet moving off of the device platform, in precisely the same way that they do for the ladder rungs. The present mid-step ladder attachment substantially fulfills those needs.

### SUMMARY

Typically, when employing a rigid ladder to perform work at a particular elevated position, a user will climb up to and stand atop either the ladder rung formed at that height position or atop an attached prior art device that, in effect, functions as an extension of the surface area of that rung—at that height position. However, as previously described, that particular standing position, much less those provided by the rungs immediately above and below, might not always be exactly optimum for a given user to perform a given task. Furthermore, even to the extent that a standing platform ladder attachment of the prior art might provide a standing surface that not coplanar with a ladder rung, that standing surface, invariably, is a platform that (1) is disposed predominantly, if not entirely, longitudinally outward of the area that is laterally bookended by the ladder rails at that elevation and (2) is a cantilever structure whose fixed end is subjected to enormous shear stress when the platform is stood upon, The former characteristic of comparable (in terms of their creating a standing position between two adjacent ladder rungs) prior art ladder attachment devices creates a safety hazard not posed by the rungs themselves; absence of lateral barriers that would prevent a user from inadvertently stepping or sliding his foot beyond a lateral edge of the standing platform. The latter characteristic of those prior art solutions creates a risk of catastrophic failure due to intense shear stress at their fixed ends.

Therefore, it is a first object of the present invention to provide a ladder attachment device that creates a standing platform that is positioned vertically intermediate two adjacent ladder rungs. In one aspect of the invention, the present attachment device features a rung-like standing platform that is supported, at each of its lateral ends by vertically-oriented, rail-like supports that are, in fact, sheet material whose respective upper and lower portions are shaped to socket fit over ladder rungs and secure the attachment to them. The standing platform is attached to the respective middle portions of the supports—rendering the standing platform vertically halfway between the two mounted ladder rungs to, presumably, provide a more perfect standing position for the device user.

It is a second object of the present invention to provide a “mid-rung” ladder attachment device that is at least as stable and sate to stand and maneuver upon as is an actual rung of the ladder to which the device is mounted, In another aspect of the invention, rather than the standing platform being attached to a support element along only [a segment of] the platform's inner longitudinal edge in cantilever fashion, the entire perimeters of this rectangular tubular element's opposing laterally outer ends are welded to vertical supports having flat surface areas which perpendicularly abut them. Consequently, shear stress is distributed throughout lengthier areas of platform-support attachment than is typically the case with the platform elements found in prior art devices, and less torque is applied to those areas of attachment than is applied to the counterpart areas of many prior art devices. This makes the present invention more structurally secure.

Finally, it is a third object of the present invention to provide a ladder attachment device that can be stably and securely attached to a ladder without using any mechanical fasteners. In another aspect of the present invention, its support frame elements, to which its standing platform element is attached, feature rectangular recesses formed in their upper left/right and lower left/right portions to enable them to conformingly fit over a typical, rectangular cross-sectioned ladder rung. Furthermore, its standing platform element is positioned, relative to the rung-receiving recesses, such that when the platform is stood upon, the user's weight imparts virtually no moment on the present device and, instead, applies only downward force along the sections of contact, between the device and the ladder rungs to which it is mounted, at the base of the four respective rung-receiving recesses. So, there is no applied directional force to urge detachment of the device from the mounted rungs.

### BRIEF DESCRIPTION OF THE DRAWINGS

FIG. 1 is a side perspective view of a ladder attachment device in accordance with the present disclosure; and

FIG. 2 is a top outer perspective view of the attachment device of FIG. 1, the device being shown mounted to a ladder for use as a standing platform.

### DETAILED DESCRIPTION OF THE PREFERRED :EMBODIMENTS

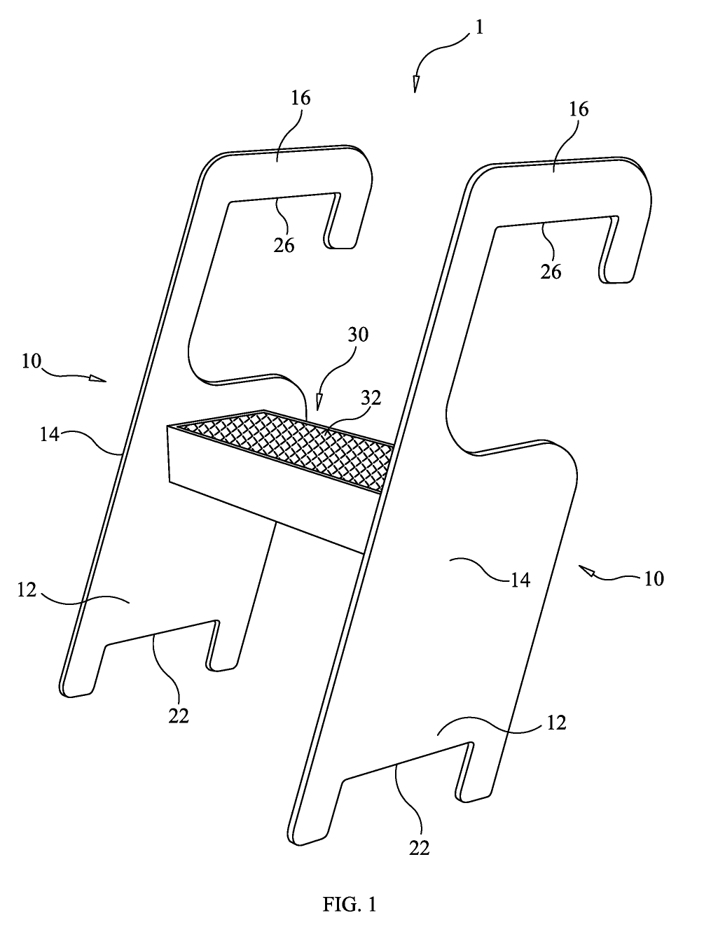

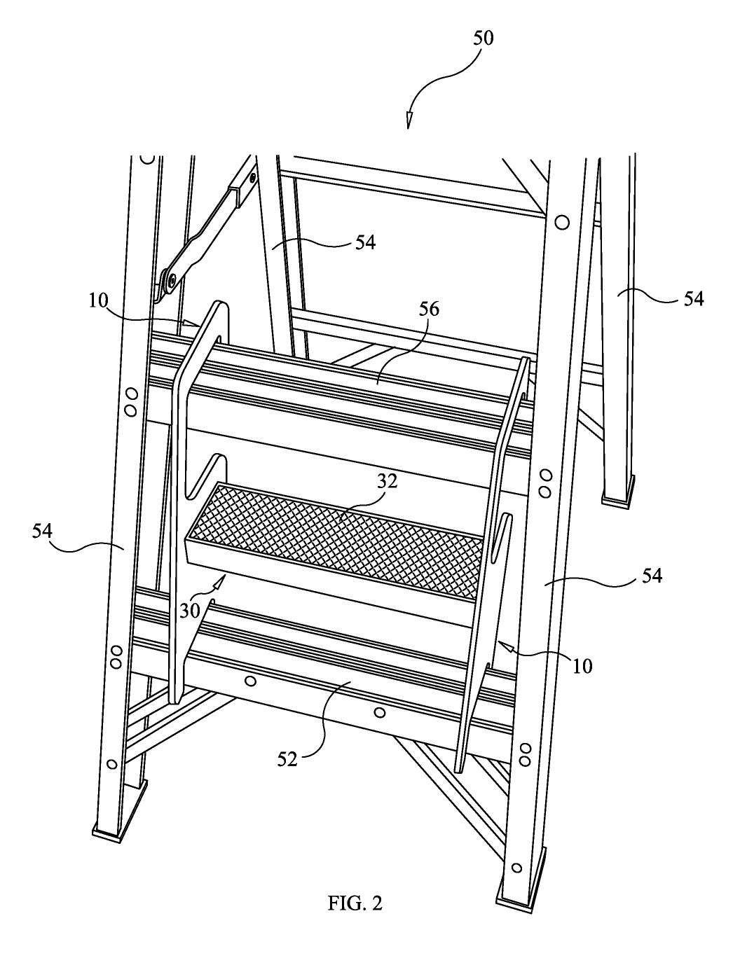

Referring now to FIGS. 1 and 2, there is illustrated a preferred embodiment of the present invention for a mid-step ladder attachment device 1. As shown and as described in its most simple form, the present device is defined by having the following three components: (1) a vertically oriented first support frame element 10 that has an upper portion 16 configured to be placed over a ladder rung, a middle portion 14 and a lower portion configured to be placed over another ladder rung; (2) a second frame element 10 of identical configuration; and (3) a standing platform 30 that extends laterally between and connects the support frames 10.

The right and left support frames 10 are mirror images of each other. In a preferred embodiment, each support frame 10 is a single piece of rigid sheet material, such as aluminum, steel, an alloy or a hard plastic, that is shaped by a molding or high pressure cutting process (e.g., by a laser jet or water jet cutter). Each frame 10 is comprised of the aforementioned three portions, although, no clear demarcations exist between them. The upper portion 16 is, essentially, an inverted, leaning J-shape that forms an upper receiving recess 26 that, preferably, is rectangular to conformingly fit over three sides of a rectangular cross-sectioned ladder rung 56, as illustrated in FIG. 2. The lower portion 12 is an inverted, leaning U-shape that forms a lower receiving recess 22 that is also rectangular to conformingly fit over the adjacent lower ladder rung 52. The middle portion 14 of each support frame 10 is simply a quadrilateral section to which the standing platform 30 is attached. The support frames 10 lie in vertical planes normal to the horizontal axis of the platform 30.

Because the support frames 10 are laterally spaced such that their respective upper receiving recesses 26 and lower receiving recesses 22 fit over the lateral near-ends of standard ladder rungs 52, 56 (i.e., close to where the horizontal ladder rungs 52, 56 meet the vertical ladder rails 54), there is, necessarily, an inverse relationship between the lateral thickness of the two support frames 10 and the lateral length of the standing platform 30 that spans between their middle portions 14. By OSHA standards, the space between the rails of a portable ladder must be at least 11.5 inches (29 C.F.R. 1926.1053(a)(4)(ii)). Therefore, so that there are at least slight clearances between the laterally outer faces of the attachment support frames 10 and the rails 54 of the ladder 50 to which it is mounted (as can be gleaned from viewing FIG. 2), the respective outer faces of the support frames 10 should be no more than 10.5 inches apart from each other. Furthermore, the supports 10 should be minimally thick enough to withstand the anticipatable loads to be placed on them without risk of them buckling.

If the support frames 10 and standing platform 30 are fabricated of metal, the standing platform 30 is a rectangular tube (or of a 3-sided geometry with no tube bottom wall) that is welded, at both of its lateral ends, to the inner faces of the support frames 10. This configuration maximizes the weld joint area to minimize the shear stress experienced at any point, along the platform-frame area of attachment, due to load presented by a user's body weight. If the support frames and standing platform are fabricated of plastic, the standing platform 30 and one of the support frames 10 can be a unitary molded piece, and the other end of the platform can be welded to the other frame 10. In any case, relative to many cantilever-style prior art ladder attachments designed to provide standing support, the present device is more reliably constructed in that those prior art devices experience greater torque and shearing forces due to creation of moment arms when weight is placed upon their standing platforms and, typically, by having smaller areas of load distribution (i.e., the areas of horizontal platform-vertical support attachment). This distinction makes the present apparatus less likely to experience catastrophic failure than many of its prior art counterparts.

Aside from having a non-cantilever configuration, the attachment 1 has a couple of other characteristics designed to minimize potentially destabilizing torque generation during use. For one, the standing platform 30 is vertically positioned such that its planar, or composite planar, top surface (i.e., the standing surface) 32 forms a plane vertically equidistant from the parallel planes formed by the respective bases of the rectangular-shaped upper and lower rung receiving recesses 26, 22 formed in each support frame 10. For another, the standing platform 30 is longitudinally dimensioned and positioned such that its entire longitudinal width resides within an imaginary zone of width that extends from the vertical plane along which the inner longitudinal edge of the upper ladder rung 56 lies to the parallel plane along which the outer longitudinal edge of the next lower rung 52 lies—and the opposing inner and outer longitudinal edges of the platform 30 are equidistant from those respective inner and outer rung planes.

Finally, in order to prevent foot slippage, it is preferred that the standing platform 30 have a frictional standing surface 32. For example, a soft rubber corrugated mat can be adhesively bonded to the top surface of the metal or plastic platform 30 to provide such a standing surface

Aspects of various embodiments of the present invention that are not recited above or claimed below may be noted from observing the illustrations included herein.

What is claimed is:

1. An apparatus that attaches to a ladder, of the type formed by laterally-spaced rails connected by vertically-spaced rungs, to provide a step that is positioned vertically midway between two adjacent ladder rungs, the apparatus comprising:
a pair of support frames for supporting a standing platform, wherein the support frames are laterally-spaced and each comprises upper, middle and lower portions, wherein the upper portion is defined by an inverted J-shaped receiving recess configured to fit over the adjacent upper rung, the lower portion is defined by an inverted U-shaped receiving recess configured to fit over the adjacent lower rung; and
a standing platform for a user to stand upon, wherein the standing platform, at its lateral ends, is attached to the respective middle portions of the support frames, and wherein the standing platform is positioned approximately vertically midway between the adjacent rungs when the upper and lower portions of the attachment are fitted over them. The apparatus of claim 1, wherein each of said support frames is defined by sheet material arranged in a plane normal to the axis of said standing platform, and wherein said upper and lower portion receiving recesses are each configured to be disposed over three sides of a rectangularly tubular ladder rung.

3. The apparatus of claim 1, wherein both of said receiving recesses are rectangular, and wherein the standing surface of said standing platform is along a plane parallel to and approximately equidistant from the planes along which the respective bases of said receiving recesses lie.

4. The apparatus of claim 1, wherein said standing platform is configured such that when said upper and lower portion receiving recesses are fitted over the adjacent ladder rungs, substantially all of the longitudinal width of said standing platform is disposed within a zone of longitudinal width that extends from the inner longitudinal edge of said adjacent upper rung to the outer longitudinal edge of said adjacent lower rung.

5. The apparatus of claim 1, wherein said standing platform is supported by said support frames in a non-cantilever manner.

6. The apparatus of claim 1, herein said standing platform has a frictional standing surface.
